(19) United States
(12) Patent Application Publication
(10) Pub. No.: US 2023/0220314 A1
(43) Pub. Date: Jul. 13, 2023

(54) A DECONTAMINANT AQUEOUS SOLUTION FOR DECONTAMINATING DIISOCYANATE DRUM AND A METHOD OF USING IT

(71) Applicant: BASF SE, Ludwigshafen Am Rhein (DE)

(72) Inventors: Kang HAN, Shanghai (CN); Xiao Qing LV, Shanghai (CN); Zhi Zhong TANG, Guangzhou, Guangdong (CN); Xiu Zhi ZHANG, Guangzhou, Guangdong (CN); Ying-Hao LIU, Shanghai (CN); Chuan Gang ZHU, Guangzhou, Guangdong (CN); Jian Hong LIANG, Guangzhou, Guangdong (CN); Hu ZENG, Guangzhou, Guangdong (CN)

(21) Appl. No.: 17/997,146

(22) PCT Filed: Apr. 21, 2021
(86) PCT No.: PCT/EP2021/060296

§ 371 Date: Oct. 26, 2022

(30) Foreign Application Priority Data
Apr. 29, 2020 (WO) PCT/CN2020/087780

(51) Int. Cl. C11D 7/50; C11D 11/00; C11D 7/26; C11D 7/06; C11D 3/43; C11D 3/04; A62D 3/36

(52) U.S. Cl. CPC C11D 7/5022; C11D 11/0041; C11D 7/261; C11D 7/263; C11D 7/06; C11D 3/43; C11D 3/044; A62D 3/36; A62D 2101/26

(57) ABSTRACT

Disclosed herein is a decontaminant aqueous solution for decontaminating diisocyanate drum, including 20-97 wt % of at least one alcohol or derivative thereof, based on the total weight of decontaminant aqueous solution, and an alkaline source in an amount effective to provide the solution a pH of at least 8. Further disclosed herein is a method for decontaminating diisocyanate residues in an emptied drum with the decontaminant aqueous solution.

### TECHNICAL FIELD

The present invention relates to a decontaminant aqueous solution for decontaminating diisocyanate drum, and to a method for decontaminating diisocyanate residues in emptied drum with said decontaminant aqueous solution.

### BACKGROUND

Polyurethanes are suitable for a large number of applications, for example cushioning materials, thermal insulation materials, packaging, automobile-dashboards, or construction materials. One important starting material for preparing polyurethane is isocyanate compound, such as MDI/TDI. However, the post-treatment of large numbers of waste MDI/TDI drums is a continuous concern in the art.

So far, the treatment for this kind of hazardous waste drums is mostly by incineration, for which manufacturers have to pay the qualified third-party companies capable of this treatment. The prior art also discloses several decontamination methods to treat the waste MDI/TDI drums.

“Guidelines for the Responsible Management of Empty Diisocyanate Drums” issued by European Diisocyanate & Polyol Producers Association (ISOPA) on November 2001 disclosed two methods for decontaminating diisocyanate residues in emptied drum, wherein in method A, a decontaminant solution comprising 8-10% sodium carbonate and 2% liquid soap in water is added into the drum to wash it for more than 1 week; in method B, a decontaminant solution comprising 20 ml potassium soap and 350 ml PEG 400 in 700 ml water is added into the drum to wash it for more than one week.

“Aromatic diisocyanate residues in emptied drums: full-scale evaluations of optimized monoethanolamine-based neutralization formulations” issued by International Isocyanate Institute on April 2014 disclosed a method for washing the emptied diisocyanate drum, wherein a decontaminant solution comprising 33% commercial detergent (3% content of ethanolamine) in 67% water is added into the drum to wash it for 24 hours.

By using the corresponding decontaminant solution, the diisocyanate residues in drums are converted into harmless polyurea/polyurethane compounds and carbon dioxide gas. However, all these decontaminant solutions just show poor washing efficiency.

Therefore, it is still required to provide a decontaminant solution for decontaminating diisocyanate drum that shows improved washing efficiency.

### SUMMARY OF THE PRESENT INVENTION

An object of this invention is to overcome the problem of the prior art discussed above and to provide a decontaminant aqueous solution for decontaminating diisocyanate drum that can well convert the toxic MDI/TDI residue into nontoxic polyurea/polyurethane in a shorter time.

Surprisingly, it has been found by the inventors that the above object can be achieved by a decontaminant aqueous solution for decontaminating diisocyanate drum comprising

a) 20-97 wt % of at least one alcohol and/or derivative thereof, based on the total weight of decontaminant aqueous solution; and

b) an alkaline source in an amount effective to provide the solution a pH of at least 8.

In a further aspect, the invention relates to a method for decontaminating diisocyanate residues in emptied drum with the decontaminant aqueous solution according to the invention, comprising the following steps:

i) adding the solution into the drum to an extent that at least 10 vol % of drum is filled;

ii) shaking or rotating the drum for a certain time; and

iii) removing and filtering the solution, and then collecting the filtered solution for usage in next drum.

It has been surprisingly found in this application that, by washing empty diisocyanate drum with said decontaminant aqueous solution, washing efficiency is significantly increased.

### BRIEF DESCRIPTION OF THE DRAWINGS

FIG. 1 shows FTIR spectrum of reacted residues in washed MDI drums.

FIG. 2 shows FTIR spectrum of reacted residue in washed TDI drum.

FIG. 3 shows the effect of temperature on the washing capacity.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

Unless otherwise identified, all percentages (%) are “percent by weight”.

Unless otherwise identified, the temperature refers to room temperature and the pressure refers to ambient pressure.

As used herein, “empty drum” is one which is “drip free”. This means that the drum has be emptied according to the practices commonly employed to remove the diisocyanate from the drum. Herein, the whole disclosure of “Guidelines for the Responsible Management of Empty Diisocyanate Drums” issued by European Diisocyanate & Polyol Producers Association (ISOPA) on November 2001 is explicitly incorporated by reference into this description.

In one aspect, the present invention provides a decontaminant aqueous solution for decontaminating diisocyanate drum, comprising

a) 20-97 wt % of at least one alcohol and/or derivative thereof, based on the total weight of decontaminant aqueous solution; and

b) an alkaline source in an amount effective to provide the solution a pH of at least 8.

In a more preferred embodiment, the present invention provides a decontaminant aqueous solution for decontaminating diisocyanate drum, comprising

a) 35-70 wt % of at least one alcohol, based on the total weight of decontaminant aqueous solution; and

b) an alkaline source in an amount effective to provide the solution a pH of at least 10.

In another more preferred embodiment, the present invention provides a decontaminant aqueous solution for decontaminating diisocyanate drum, comprising

a) 20-97 wt % of at least one alcohol derivative, based on the total weight of decontaminant aqueous solution; and

b) an alkaline source in an amount effective to provide the solution a pH of at least 8.

Component (a)

The alcohols that can be used in the invention are aliphatic alcohols or the derivative thereof in the art, such as diols having from 2 to 6 carbon atoms, e.g. ethylene glycol, diethylene glycol, triethylene glycol, 1,3-propanediol, 1,2-propanediol, dipropylene glycol, 1,4-butanediol, 1,5-pentanediol, 1,6-hexanediol and corresponding oligomer or polymer thereof. Preferably, the alcohol comprises at least one of ethylene glycol, diethylene glycol, triethylene glycol, or polyethylene glycol having a molecular weight of from 100 to 600. More preferably, the alcohol solution comprises waste alcohol from PESOL (Polyester Polyol) production line, for the purpose of cost saving and simultaneously similar washing performance.

The amount of alcohol is in the range of 35 to 70 wt %, preferably 35 to 55 wt %, based on the total weight of the decontaminant aqueous solution. The addition of alcohol is beneficial for the dispersion of isocyanate in water. Moreover, controlling the relative amount of alcohol and water is important for final conversion product. If the amount of alcohol is lower than the lower limit, the formed product in drum is mainly 4,4-diphenyl methane diamine, which is toxic and cannot be accepted. If the amount of alcohol is higher than the upper limit, the formed product in drum is mainly polyurethane, which, although nontoxic, leads to dramatically increased viscosity of the decontaminant solution (finally, a paste-like product).

The alcohol derivatives that can be used in the invention are selected from polyethylene glycol based derivative, preferably ether-capped PEG, more preferably alkyl ether-capped PEG, such as C₁₋₆-alkyl ether-capped PEG with number-average molecular weight (Mn) of 150-600, preferably 200-450. More preferably, PEG dimethyl ether is used to wash the drums.

The amount of alcohol derivative is in the range of 20 to 97 wt %, preferably 35 to 80 wt %, more preferably 40-65 wt % based on the total weight of the decontaminant aqueous solution. It is surprisingly found that in the invention, the addition of alcohol derivative, especially polyethylene glycol based derivative is beneficial for the dispersion of isocyanate in water. Moreover, controlling the relative amount of alcohol derivative and water is important for final conversion product. If the amount of alcohol derivative is lower than the lower limit, the formed product in drum is mainly 4,4-diphenyl methane diamine, which is toxic and cannot be accepted. If the amount of alcohol derivative is higher than the upper limit, the formed product in drum is mainly polyurethane, which leads to dramatically increased viscosity of the decontaminant solution (finally, a paste-like product).

Component (b)

The alkaline sources that can be used in the invention are preferably alkali metal hydroxide, and a mixture thereof. Examples of suitable alkali metal hydroxides include sodium hydroxide, potassium hydroxide, and lithium hydroxide. Preferably, the alkaline source comprises at least one of sodium hydroxide, potassium hydroxide, and mixtures thereof. The alkali metal hydroxides may be added to the composition in any form known in the art, for example as solid beads, as an aqueous solution, or a combination thereof.

An effective amount of one or more alkaline sources is provided in the decontaminant solution. An effective amount is referred to herein as an amount that provides the decontaminant solution with a pH of at least 8. In case of alcohols used, the pH is at least 10, preferably 10-13; if pH is lower than 10, the conversion ratio will be low. In case of alcohol derivatives used, the pH is in the range of 8 to 13, preferably 8-11; if pH is lower than 8, the conversion ratio will be low. The addition of alkaline sources is beneficial for the conversion ratio.

The decontaminant solution may further comprise, as optional component, at least one of an anionic surfactant, a nonionic surfactant, a cationic surfactant, and a zwitterionic surfactant commonly used in the art.

In another aspect, the present invention further provides a method for decontaminating diisocyanate residues in emptied drum with decontaminant aqueous solution according to the invention, comprising the following steps:

i) adding the solution into the drum to an extent that at least 10 vol % of drum is filled;

ii) shaking or rotating the drum for a certain time; and

iii) removing and filtering the solution, and then collecting the filtered solution for usage in next drum.

In a more preferred embodiment, the method further comprises step i)′, before step i), heating the decontaminant aqueous solution to a temperature of 25 to 90° C.

According to the invention, the temperature is preferably in the range of 45 to 90° C., more preferably 50 to 70° C. The elevated temperature is beneficial for the conversion ratio and washing capacity. If the temperature is lower than the lower limit, it will take more time to wash diisocyanate residue in drum.

In another preferred embodiment, the method further comprises step iii)′, after step iii), rinsing the inner wall of drum with water or weak acidic solution at pH 5-6. Preferably, the weak acidic solution is selected from acetic acid and citric acid.

For the purpose of rapid and complete reaction, the decontaminant solution is added into the drum to an extent that at least 20 vol % of drum is filled.

During the step ii), the drum is shaken or rotated for at most one hour, preferably 10 minute to 30 minute. The treatment time of the present invention is much shorter than that of the prior art (about one week).

During the step ii), the solution is physically stirred by any device that can be put into the drum and is beneficial to improve dispersion effect, such as iron chain. Physical stirring is beneficial for the dispersion of isocyanate in water and thus can enhance the washing performance.

If possible, all the steps are operated with automatic equipment, which can accelerate the treatment process.

### EXAMPLE

The present invention will now be described with reference to Examples and Comparative Examples, which are not intended to limit the present invention.

Emptied MDI/TDI drums: available from BASF system house Waste alcohol: from PESOL production line of BASF PEG dimethyl ether: under the brand of OURCHEM, with number-average molecular weight (Mn) of about 250

The following methods were used to determine the conversion ratio:

FTIR: The sample (i.e., solid obtained by filtration after reaction) was measured by IR surface spectrum by ATR-technique (Standard W00161). The spectrum is normalized with non-reacted functional groups which show relatively stable signals e.g. 3030 cm⁻¹ of the aromatic C—H stretching and 1603 cm⁻¹, 1509 cm⁻¹ of C═C bending and C═C stretching in phenyl group.

Conversion ratio is determined by comparing the peak integral area of NCO group (2230-2280 cm⁻¹) of the sample with pure MDI/TDI. The integral area of NCO absorption peaks in pure MDI/TDI is set as A0, and the integral area of remaining NCO peaks of the sample is set as A1. The conversion ratio is determined by the following formula:

Conversion ratio=(A0−A1)/A0*100%

### Example 1

Preparation of Decontaminant Aqueous Solution

Solid NaOH/KOH was added in a 40 wt % ethylene glycol aqueous solution in order to adjust pH value to 10.

Washing Procedure

Then, an empty MDI drum was washed with the prepared decontaminant aqueous solution according to the following steps:

step i): Agitate the decontaminant aqueous solution for 10 minute and store it in oven under 60° C. Then the solution is ready for use.

step ii): Add the decontaminant aqueous solution into drum (around 20 vol % according to the size of drum).

step iii): Shake or rotate the drum for certain time(about 15 min).

step iv): Remove and filter the solution, and then collect the filtered solution for usage in next drum.

step v): Rinse the inner wall of drum with water.

The FTIR spectrum shows that the conversion ratio is more than 95%.

### Example 2

Recycling Use

Solid NaOH/KOH was added in a 45 wt % ethylene glycol aqueous solution in order to adjust pH value to 13.

Then, a 500 mL container containing 10 g MDI was washed with 100 g prepared decontaminant aqueous solution according to the following steps:

step i): Agitate the decontaminant aqueous solution for 10 minute and store it in oven under 60° C. Then the solution is ready for use.

step ii): Add the decontaminant aqueous solution into container (about 20 vol %).

step iii): Shake or rotate the container for certain time(about 10 min).

step iv): Remove and filter the solution, and then collect the filtered solution for usage in next container.

step v): Rinse the inner wall of container with water.

The filtered decontaminant solution was used to treat next MDI container. Here we compare the NCO signal in FTIR spectrum (2230-2280 cm⁻¹ is the peak for NCO group). The decontaminant solution was repeatedly used for 6 times, and the washing capacity just decreased when the solution is turned to the 6th container (conversion ratio is more than 95% for the first five containers). This decrease may be due to the neutralization of alkaline decontaminant solution by generated CO₂ (pH value is decreased to 9).

TABLE 1
Conversion ratio in recycling use

| | residue in | residue in | residue in | residue in | residue in | residue in |
|---|---|---|---|---|---|---|
| | 1st | 2nd | 3rd | 4th | 5th | 6th |
| Sample | container | container | container | container | container | container |
| conversion | 97% | 96% | 96% | 96% | 96% | 50% |
| ratio, | | | | | | |
| in % | | | | | | |

### Example 3

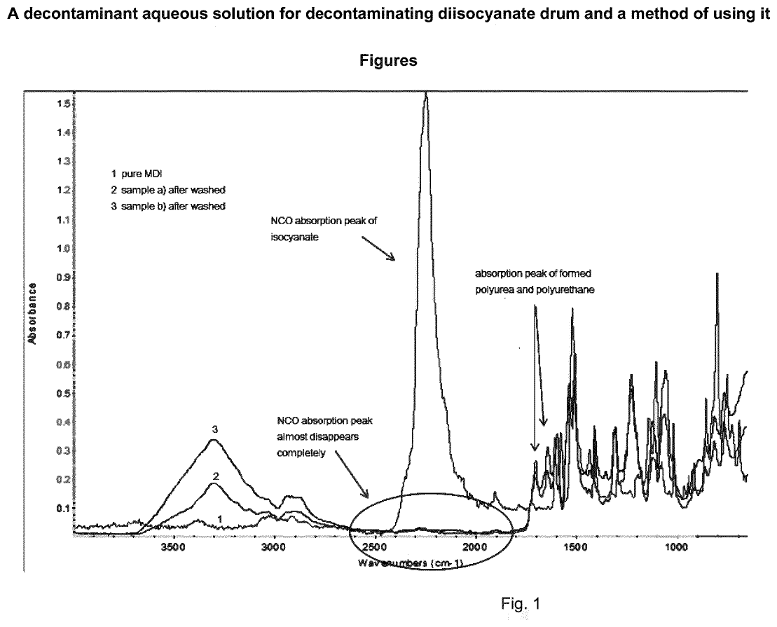

All the procedures were repeated according to example 1 except that diethylene glycol was used instead of ethylene glycol. FIG. 1 shows the peak intensity of NCO group of residues in drums, as compared with pure MDI. Sample a) is residue in 1st drum and

Sample b) is residue in 2nd drum. The result shows that the NCO signal of MDI was completely disappeared after being washed. The conversion ratio is more than 95%.

### Example 4

All the procedures were repeated according to example 1 except that waste alcohol from PESOL production line was used instead of ethylene glycol. The FTIR spectrum shows that the conversion ratio is more than 95%.

### Example 5

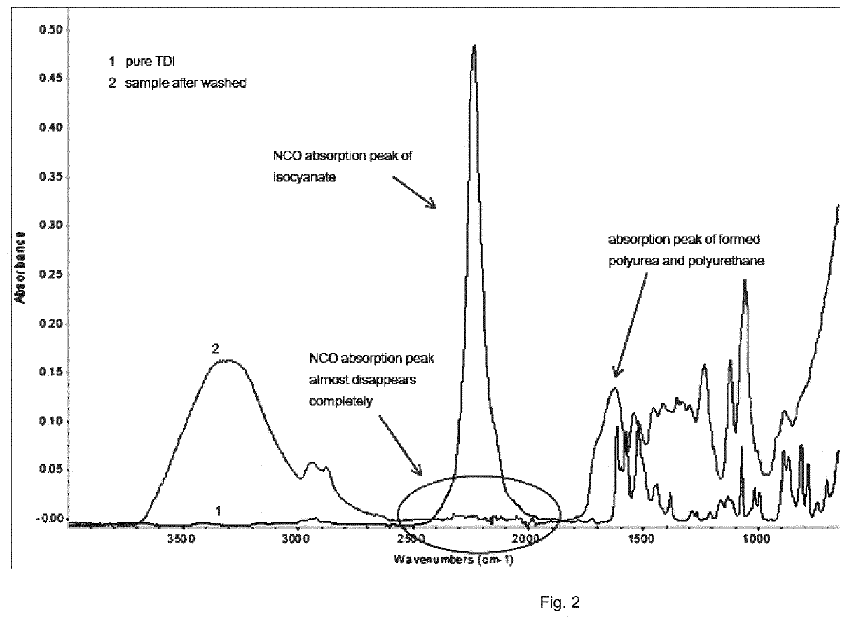

All the procedures were repeated according to example 1 except that an empty TDI drum was used instead of empty MDI drum. For TDI drum, the decontaminant solution had similar or even stronger washing capacity and conversion ratio. FIG. 2 shows that the NCO signal of TDI was completely disappeared after being washed. The conversion ratio is more than 95%.

a. Effect of Temperature on Conversion Ratio (Example 6-Example 8)

The inventors tested the effect of temperature on conversion ratio. Inventive examples 6-8 and comparative examples 1-2 were conducted according to the procedure stated above for Example 1, except that the temperature was altered from 25° C. to >50° C., and pH was constant at 12 in 50% ethylene glycol aqueous solution. The result was summarized in the following Table 2.

TABLE 2
Effect of the temperature on conversion ratio

| Examples | Temperature (° C.) | Conversion ratio (%) |
|---|---|---|
| Comparative Example 1 | 25° C. | <10% |
| Comparative Example 2 | 40° C. | <50% |
| Inventive Example 6 | 45° C. | >90% |
| Inventive Example 7 | 50° C. | >90% |
| Inventive Example 8 | >50° C. | ~100% |

As compared with Comparative Examples 1-2 at a temperature of 25° C. and 40° C., the Inventive Examples 6-8, at a temperature higher than 40° C., show conversion ratios of >90%, much higher than that of Comparative Examples 1-2. For Comparative Examples 1-2 at a temperature of 25° C. and 40° C., it will take about one hour to wash diisocyanate residues in drum.

b. Effect of pH on Conversion Ratio (Example 9-Example 10)

The inventors tested the effect of pH on conversion ratio. Inventive examples 9-10 and comparative examples 3-4 were conducted according to the procedure stated above for Example 1, except that pH was altered from 7 to ≥12 in 55% ethylene glycol aqueous solution, and the temperature was constant at 50° C. The result was summarized in the following Table 3.

TABLE 3
Effect of the pH on conversion ratio

| Examples | pH | Conversion ratio (%) |
|---|---|---|
| Comparative Example 3 | 7 | <10% |
| Comparative Example 4 | 8-9 | <30% |
| Inventive Example 9 | 10-11 | >90% |
| Inventive Example 10 | ≥12 | ~100% |

As compared with Comparative Examples 3-4 at a pH of 7 to 9, the Inventive Examples 9-10, at a pH higher than 10, show conversion ratios of >90%, much higher than that of Comparative Examples 3-4.

c. Effect of the Amount of Alcohol on Conversion Product (Example 11)

The inventors tested the effect of the amount of alcohol on conversion product. Inventive example 11 and comparative examples 5-6 were conducted according to the procedure stated above for Example 1, except that the amount of alcohol was altered from <30 wt % to >55 wt %, and pH was constant at 12 and the temperature was constant at 50° C. The result was summarized in the following Table4.

TABLE 4
Effect of the amount of alcohol on conversion product

| | The amount of | |
|---|---|---|
| Examples | alcohol (wt %) | Conversion product |
| Comparative Example | <30 wt % | Mainly 4,4-diphenyl |
| 5 | | methane diamine |
| Inventive Example 11 | 30-55 wt % | Mainly nontoxic polyurea, |
| | | and byproduct polyurethane |
| Comparative Example | >55 wt % | mainly polyurethane |
| 6 | | |

If the amount of alcohol is lower than 30 wt %, the formed product in drum is mainly 4,4-diphenyl methane diamine, which is toxic and cannot be accepted. If the amount of alcohol is higher than 55 wt %, the formed product in drum is mainly polyurethane, which leads dramatically increased viscosity of the decontaminant solution (finally, a paste-like product). In the case of the latter, although increased viscosity is not beneficial for washing, the product polyurethane is nontoxic.

d. Effect of Temperature on Washing Capacity

The inventors conducted another experiment to obtain the washing capacity of decontaminant solution at different temperatures. All the procedures were repeated according to example 1 except that the temperature was altered from 40 to 60° C.

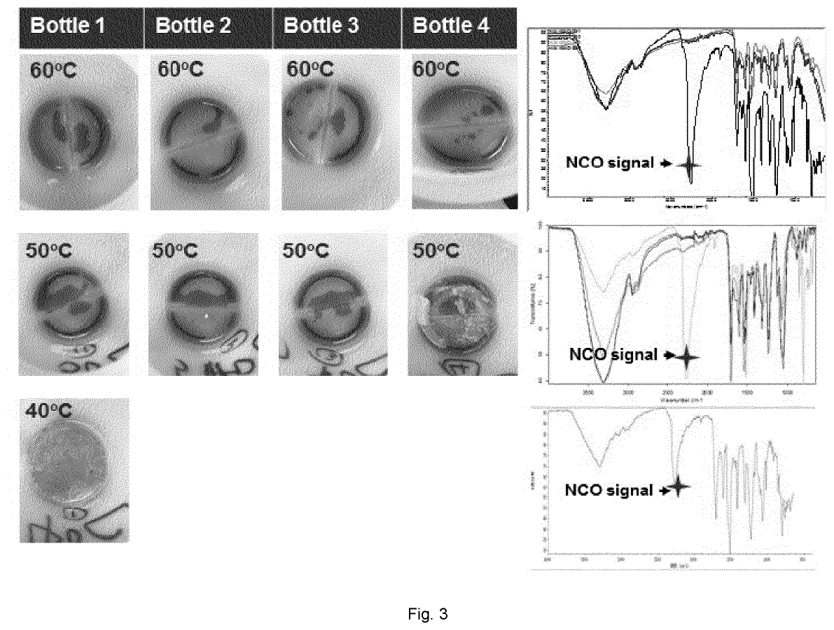

It can be seen from FIG. 3 that, the empty MDI drum was well washed when temperature was greater than or equal to 60° C. All isocyanate crystals were washed down from the side wall and bottom of the drum. The FTIR spectrum indicates that the washing effect decreased at the 4th drum. When the temperature was decreased to 50° C., the NCO signal was observed for the 3rd drum, which means the decrease of the washing capacity, and there was obvious residue observed in the 4th drum. When the temperature is decreased to 40° C., the first drum was not well washed. According to the invention, 20 kg washing solution can be used for more than 20 drums.

e. Effect of the Amount of Alcohol Derivative on Conversion Ratio (Example 12

### Example 21

To test the effect of the amount of alcohol derivative on conversion ratio, decontaminant aqueous solutions with varying contents of 10% to 97% PEG dimethyl ether were prepared, as shown by Inventive examples 12-21 and comparative examples 7 in the following Table 5. All decontaminant aqueous solutions have constant pH value of 13 by adding solid KOH. The conversion ratio was also summarized in the following Table 5.

Washing procedure is as follows:

A 500 mL container containing 6 g MDI was washed with 50 mL each decontaminant aqueous solution prepared above according to the following steps:

step i): Agitate the decontaminant aqueous solution for 10 minute and store it in oven under 60° C. Then the solution is ready for use.

step ii): Add the decontaminant aqueous solution into container (about 10 vol %).

step iii): Shake or rotate the container for certain time (about 10 min).

step iv): Remove and filter the solution, and then collect the filtered solution for usage in next container.

step v): Rinse the inner wall of container with water.

TABLE 5
Effe

| | The amount of alcohol | |
|---|---|---|
| Examples | derivative (wt %) | Conversion ratio (%) |
| Comparative Example | 10 wt % | <30% |
| 7 | | |
| Inventive Example 12 | 20 wt % | >90% |
| Inventive Example 13 | 30 wt % | >90% |
| Inventive Example 14 | 40 wt % | >90% |
| Inventive Example 15 | 50 wt % | >90% |
| Inventive Example 16 | 60 wt % | ~100% |
| Inventive Example 17 | 70 wt % | ~100% |
| Inventive Example 18 | 80 wt % | ~100% |
| Inventive Example 19 | 90 wt % | ~100% |
| Inventive Example 20 | 94 wt % | ~100% |
| Inventive Example 21 | 97 wt % | ~100% |

As shown in table 5, Inventive examples 12-21 with PEG dimethyl ether contents of 20%-97% show conversion ratios of >90%, much higher than that of Comparative Examples 7 with PEG dimethyl ether contents of 10%. By using decontaminant aqueous solution with contents of 60% to 97% PEG dimethyl ether, nearly 100% MDI conversion ratios are obtained. Those results show that higher contents of PEG dimethyl ether are beneficial for the conversion ratio.

f. Effect of pH of Alcohol Derivative Aqueous Solution on Conversion Ratio

### Example 22-Example 26

To test the effect of pH of alcohol derivative aqueous solution on conversion ratio, the decontaminant aqueous solutions with pH value in a range of 7 to 12 were prepared by adding solid KOH into PEG dimethyl ether aqueous solution with a 97% PEG dimethyl ether content, as shown by Inventive examples 22-26 and comparative examples 8 in the following Table 6. The conversion ratio was also summarized in the following Table 6.

The washing procedure is the same as stated above in item e, except that the decontaminant aqueous solutions contain 97% PEG dimethyl ether, with pH varying from 7 to 12.

TABLE 6
Effect of the amount of alcohol derivative on conversion product

| Examples | pH | Conversion ratio (%) |
|---|---|---|
| Comparative Example | 7 | <30% |
| 8 | | |
| Inventive Example 22 | 8 | >90% |
| Inventive Example 23 | 9 | ~100% |
| Inventive Example 24 | 10 | ~100% |
| Inventive Example 25 | 11 | ~100% |
| Inventive Example 26 | 12 | ~100% |

As shown in table 6, Inventive examples 22-26 with pH of at least 8 show conversion ratios of >90%, much higher than that of Comparative Examples 8 with pH of 7. When decontaminant aqueous solutions with pH of above 9 are used, nearly 100% MDI conversion ratios can be obtained. Those results show that higher pH of decontaminant aqueous solutions are beneficial for the conversion ratio.

g. Effect of Different Amount of Alcohol Derivative on Conversion Ratio at pH 10

### Example 27-Example 29

To test the effect of the amount of alcohol derivative on conversion ratio at pH 10, decontaminant aqueous solutions with varying contents of 40% to 65% PEG dimethyl ether were prepared, as shown by Inventive examples 27-29 in the following Table 7. All decontaminant aqueous solutions have constant pH value of 10 by adding solid KOH. The conversion ratio was also summarized in the following Table 7.

The washing procedure is the same as stated above in item e, except that the decontaminant aqueous solutions contain 40% to 65% PEG dimethyl ether and have constant pH of 10.

TABLE 7
Effect of different amount of alcohol
derivative on conversion ratio at PH 10

| | The amount of alcohol | |
|---|---|---|
| Examples | derivative (wt %) | Conversion ratio (%) |
| Inventive Example 27 | 40 wt % | >90% |
| Inventive Example 28 | 50 wt % | >90% |
| Inventive Example 29 | 65 wt % | >90% |

As shown in table 7, decontaminant aqueous solution of Inventive examples 27-29 with contents of 40%-65% PEG dimethyl ether and constant pH of 10 show higher conversion ratios of >90%.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents.

1. A decontaminant aqueous solution for decontaminating diisocyanate drum comprising:
a) 20-97 wt % of at least one alcohol and/or derivative thereof, based on the total weight of decontaminant aqueous solution; and
b) an alkaline source in an amount effective to provide the solution a pH of at least 8.

2. The decontaminant aqueous solution according to claim 1, wherein the decontaminant aqueous solution comprises
a) 35-70 wt % of at least one alcohol, based on the total weight of decontaminant aqueous solution; and
b) an alkaline source in an amount effective to provide the solution a pH of at least 10.

3. The decontaminant aqueous solution according to claim 1, wherein the alcohol comprises at least one component selected from the group consisting of diols having from 2 to 6 carbon atoms and a corresponding oligomer or polymer thereof.

4. The decontaminant aqueous solution according to claim 3, wherein the alcohol comprises at least one component selected from the group consisting of ethylene glycol, diethylene glycol, triethylene glycol, and polyethylene glycol having a molecular weight of from 100 to 600.

5. The decontaminant aqueous solution according to claim 1, wherein the alcohol comprises waste alcohol from PESOL production line.

6. The decontaminant aqueous solution according to claim 2, wherein the amount of alcohol is in the range of 35 to 55 wt %, based on the total weight of the decontaminant aqueous solution.

7. The decontaminant aqueous solution according to claim 2, wherein the pH is in the range of 10 to 13.

8. The decontaminant aqueous solution according to claim 1, wherein the alcohol derivative is selected from the group consisting of polyethylene glycol based derivatives.

9. The decontaminant aqueous solution according to claim 8, wherein the amount of alcohol derivative is in the range of 20 to 97 wt %, based on the total weight of the decontaminant aqueous solution.

10. The decontaminant aqueous solution according to claim 8, wherein the pH is in the range of 8 to 13.

11. The decontaminant aqueous solution according to claim 1, wherein the alkaline source is an alkali metal hydroxide, or a mixture thereof.

12. The decontaminant aqueous solution according to claim 1, wherein the alkaline source comprises at least one component selected from the group consisting of sodium hydroxide, potassium hydroxide, and mixtures thereof.

13. The decontaminant aqueous solution according to claim 1, wherein the solution further comprises at least one component selected from the group consisting of an anionic surfactant, a nonionic surfactant, a cationic surfactant, and a zwitterionic surfactant.

14. A method for decontaminating diisocyanate residues in an emptied drum with the decontaminant aqueous solution according to claim 1, comprising the following steps:
i) adding the solution into the drum to an extent that at least 10 vol % of drum is filled;
ii) shaking or rotating the drum for a certain time; and
iii) removing and filtering the solution, and then collecting the filtered solution for usage in next drum.

15. The method according to claim 14, wherein the method further comprises step i)′, before step i), wherein step i)′ comprises heating the decontaminant aqueous solution to a temperature in a range of 25 to 90° C.

16. The method according to claim 15, wherein the temperature is in the range of 45 to 90° C.

17. The method according to claim 14, wherein the method further comprises step iii)′, after step iii), wherein step iii)′ comprises rinsing the inner wall of drum with water or weak acidic solution at pH 5-6.

18. The method according to claim 17, wherein the weak acidic solution is selected from the group consisting of acetic acid and citric acid.

19. The method according to claim 14, wherein the solution is added into the drum to an extent that at least 20 vol % of drum is filled.

20. The method according to claim 14, wherein the drum is shaken or rotated for at most one hour.

21. The method according to claim 14, wherein during the step ii), the solution is physically stirred by an iron chain.

22. The method according to claim 14, wherein all the steps are operated with automatic equipment.
